(19) United States
(12) Patent Application Publication
(10) Pub. No.: US 2021/0154784 A1
(43) Pub. Date: May 27, 2021

(54) CHARGING DEVICE FOR TOOL HOLDER

(71) Applicant: Industrial Technology Research Institute, Hsin-chu (TW)

(72) Inventors: PO-HSIU KO, Taichung City (TW); MENG-CHIOU LIAO, Yunlin County (TW); CHIN-MING CHEN, Taichung City (TW)

(21) Appl. No.: 16/749,141

(22) Filed: Jan. 22, 2020

(30) Foreign Application Priority Data
Nov. 22, 2019 (TW) 108142461

(51) Int. Cl. B23Q 3/155; B21D 37/06; H02J 7/00

(52) U.S. Cl. CPC B23Q 3/15553; H02J 7/0044; B21D 37/06

(57) ABSTRACT

A charging device for a tool holder disposed in a holder grabber includes a wireless signal module disposed at the tool holder, a plurality of charging contacts disposed at the tool holder, and a charging module disposed also at the holder grabber. Each of the plurality of charging contacts is connected with the wireless signal module. The charging module includes a plurality of charging pins. When the tool holder is positioned at the holder grabber, each of the plurality of charging pins contacts at the corresponding charging contact for charging the tool holder.

### CROSS REFERENCE TO RELATED APPLICATION

This application claims the benefits of Taiwan application Serial No. 108142461, filed on Nov. 22, 2019, the disclosures of which are incorporated by references herein in its entirety.

### TECHNICAL FIELD

The present disclosure relates in general to a charging device, and more particularly to a charging device for a tool holder.

### BACKGROUND

In the art, a tool magazine of a conventional NC (Numerical control) machine tool is used for storing cutters required for a machining process, and for transferring a cutter of a work section to a target position. A conventional management of tool magazines, specifically in tool holders, usually adopts a bar-code system, which is inexpensive but only able to provide limited capacity for information storage. However, the bar code itself is vulnerable to environmental abrasion. The RFID (Radio frequency identification) technology, usually adopted for managing tool holders, has advantages in reuse and environmental tolerance, but is not for an active communication mechanism. In particular, the RFID cannot afford to provide stable data transmission within a limited time, and thus the associated transmission range would be limited. Thereupon, the application of RFID for managing the tool holders is limited.

Nevertheless, while in meeting a rising demand in autonomous and intelligent production, the existing management for tool-holders becomes insufficient. Hence, a tool-holder management is introduced to utilize the wireless communication handshaking protocol for realizing wireless communication, by which various merits in autonomous communication, low energy consumption, lower cost, more network nodes, various network topology, and rapid, reliable and safe response can be obtained. Currently, the WSN (Wireless sensor network) for tool holders is generally furnished with a specific communication interface such as a Bluetooth or a Zigbee. Due to requirements in system miniaturization, wireless transmission components and embedded detection devices, reduced battery size as well as its limited capacity become an issue in power supply. In particular, it is obvious that power storage at each recharge cannot meet practical need of individual tool holder. To versatile rechargeable tool holders in the factory, if there is a need to replace or recharge all the batteries for the tool holders, it can be expected that a huge cost in labor and time would be consumed.

Thus, an improvement upon the charging device for a tool holder for overcoming the aforesaid shortcomings is definitely urgent and welcome to the skill in the art.

### SUMMARY

In accordance with this disclosure, a charging device for a tool holder can be charged simultaneously while the tool holder is disposed at a tool grabber such as a tool magazine, a tool frame or a tool storage.

In one embodiment, the charging device for a tool holder includes a wireless signal module, a plurality of charging contacts and a charging module. The wireless signal module and the charging contacts are individually disposed at the tool holder. Each of the charging contacts is connected with the wireless signal module. The charging module, disposed at the holder grabber, includes a plurality of charging pins.

As stated, in the charging device for a tool holder provided by this disclosure, while the tool holder is positioned in the holder grabber such as a tool magazine, a tool frame or a tool storage, the tool holder can be then charged. In addition, since the tool holder would be sent back to the holder grabber after each usage, the practice of moving out all the tool folders for charging is no more necessary, and also the practice of replacing batteries for all the tool holders is not necessary as well. Thereupon, the charging device for the tool holders in this disclosure can significantly reduce the labor and time cost in the management of charging the tool holders.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic block view of the charging device for a tool holder in accordance with this disclosure;

FIG. 2 is a schematic view of an embodiment of a tool holder in accordance with this disclosure;

FIG. 3 is a schematic lateral side view of an embodiment of a charging module in accordance with this disclosure;

FIG. 4 is a schematic front view of FIG. 3;

FIG. 5 is a schematic block view of a wireless signal module and charging contacts in accordance with this disclosure;

FIG. 6 is a schematic view of an embodiment of the charging module disposed at a tool claw in accordance with this disclosure;

FIG. 7 is a schematic perspective view of an embodiment of the charging device for a tool holder in accordance with this disclosure;

FIG. 8 is a schematic perspective view of another embodiment of the charging device for a tool holder in accordance with this disclosure; and

FIG. 9 is a schematic view of an exemplary application example in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

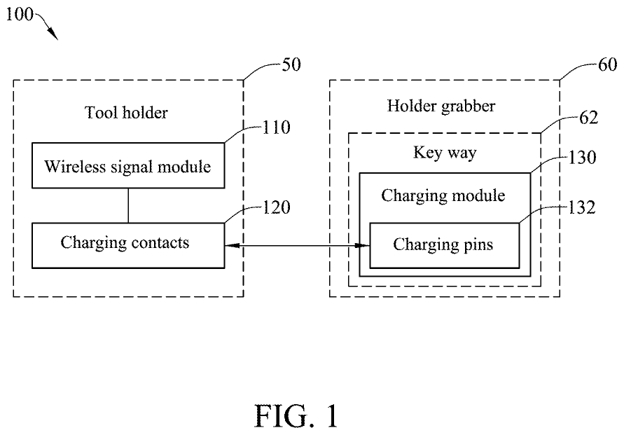

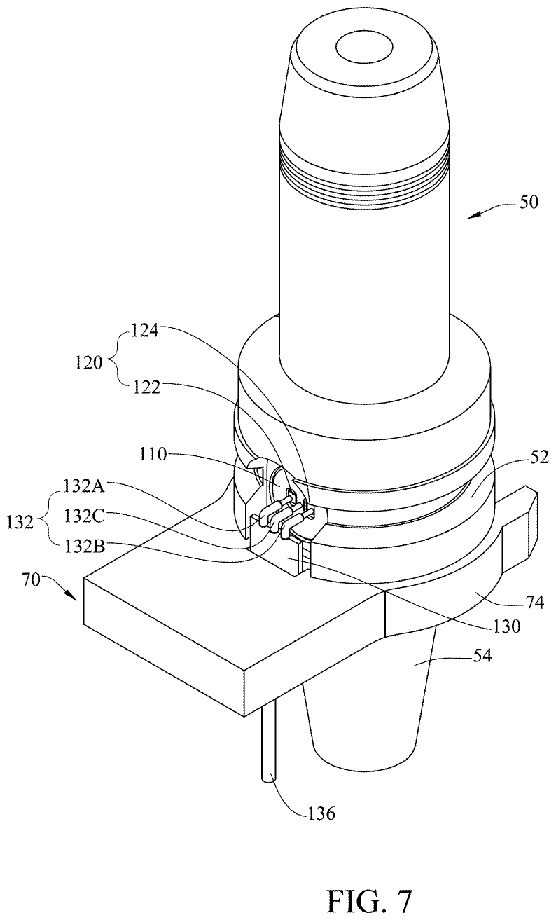

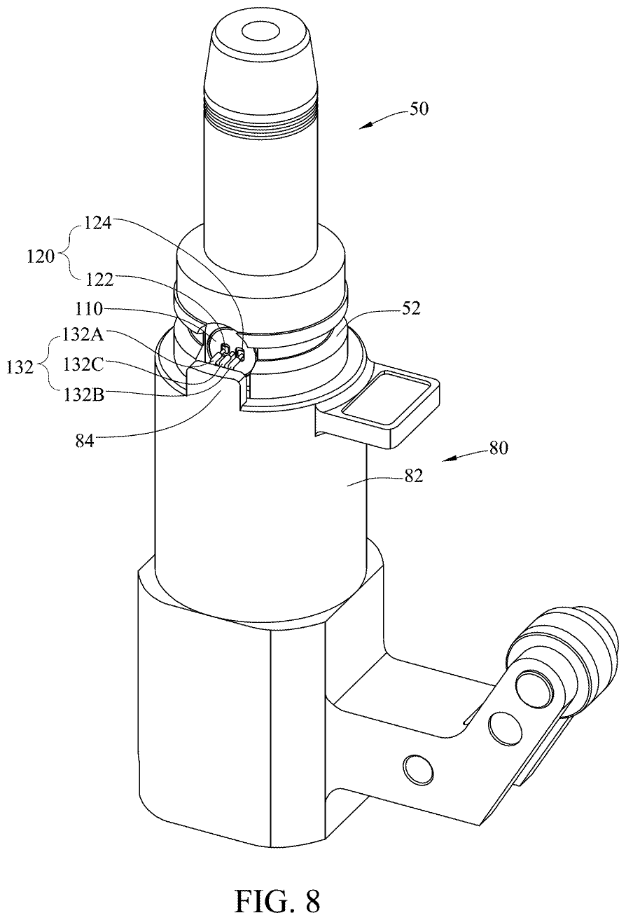

Referring to FIG. 1, an embodiment of the charging device for a tool holder in accordance with this disclosure is schematically shown in the block view. The charging device for a tool holder 100 is used for charging at least a tool holder 50. The tool holder 50 is disposed on the holder grabber 60. In this disclosure, the holder grabber 60 can be a tool magazine, a tool frame, a tool storage or the like internal device for handling the tool or cutters, such as a tool claw 70 in FIG. 7 or a tabular holder 80 in FIG. 8. No matter what kind of the aforesaid exemplary examples is, the tool holder 50 is generally furnished with a key way 62 such as a groove or a protrusion at the holder grabber 60.

In this embodiment, the charging device 100 includes a wireless signal module 110, a plurality of charging contacts 120 and a charging module 130. The wireless signal module 110, disposed inside the tool holder 50, makes the tool holder 50 as a WSN tool holder that applies wireless communication handshaking. The charging contacts 120 are disposed on the tool holder 50, and each of the charging contacts 120 is individually connected to the wireless signal module 110. On the other hand, the charging module 130, disposed inside the key way 62 of the holder grabber 60, includes a plurality of charging pins 132. The holder grabber 60 is also connected with an external power supply, so that the holder grabber 60 can charge batteries inside the wireless signal module 110 of the tool holder 50.

Under such an arrangement, as the tool holder 50 is placed into the holder grabber 60, each of the charging pins 132 is located respective to one corresponding charging contact 120 for connecting electricity to charge the tool holder 50. In addition, after being used, the tool holder 50 would be sent back to the holder grabber 60 inside the tool magazine, the tool frame or the tool storage. In other words, according to this disclosure, the practice of moving out all the tool folders 50 for charging is no more necessary, and also another practice of replacing batteries for all the tool holders 50 is also not necessary. Thereupon, the charging device 100 for the tool holders 50 can remarkably reduce the labor and time cost in the management of charging the tool holders 50.

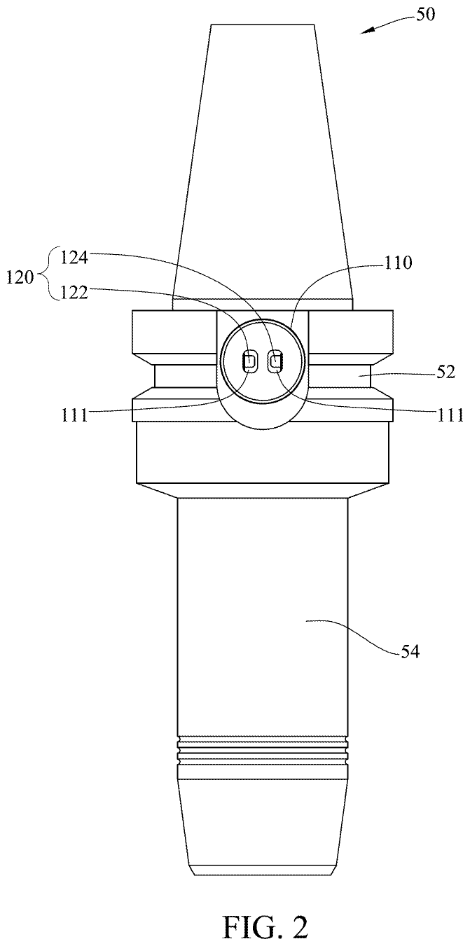

Referring to FIG. 2, an embodiment of the tool holder 50 in accordance with this disclosure is schematically shown. The tool holder 50 includes a connection portion 52 and a fixation portion 54, in which the fixation portion 54 can be clamped by a tool claw or sleeved by a tubular holder. The wireless signal module 110 can be a cylinder to be embedded into a corresponding groove of the connection portion 52. In some other embodiments, the wireless signal module 110 can be fixed to the tool holder 50 by embedding, buckling, screwing or any fixation means the like. In other words, according to this disclosure, the method for fixing the wireless signal module 110 into the tool holder 50 is not limited to using any specific means. An end surface of the wireless signal module 110 is furnished with two holes 111, the charging contacts 120 are consisted of a positive-pole contact 122 and a negative-pole contact 124, and the two holes 111 expose individually the positive-pole contact 122 and the negative-pole contact 124, respectively.

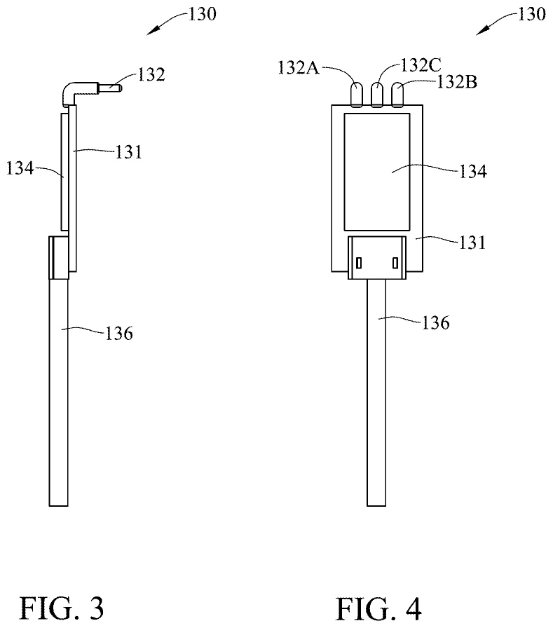

Referring to FIG. 3 and FIG. 4, lateral side and front views of the charging module 130 are schematically shown, respectively. The charging module 130 can include a main body 131 (formed as a plate), a plurality of charging pins 132, a control circuit board 134 and a charging cable 136. The control circuit board 134, mounted on the main body 131, is furnished with a charging IC (Integrated circuit) for charging the battery. The charging pins 132 (including 132A, 132B and 132C), located at one side of the main body 131, are electrically connected with the control circuit board 134. In this embodiment, the charging pins 132 include three contact pins as shown in FIG. 3; i.e., a positive-pole terminal 132A, a negative-pole terminal 132B and a signal terminal 132C. In particular, referring to FIG. 2, the positive-pole terminal 132A is connected with the positive-pole contact 122 of the charging contacts 120, the negative-pole terminal 132B is connected with the negative-pole contact 124 thereof, and the signal terminal 132C is connected with the wireless signal module 110 for performing data transmission. In another embodiment of this disclosure not shown herein, the charging pins 132 can be simply consisted of the positive-pole terminal 132A and the negative-pole terminal 132B. Namely, according to this disclosure, embodying of the charging pins are not limited to any specific example, but organized per practical requirements.

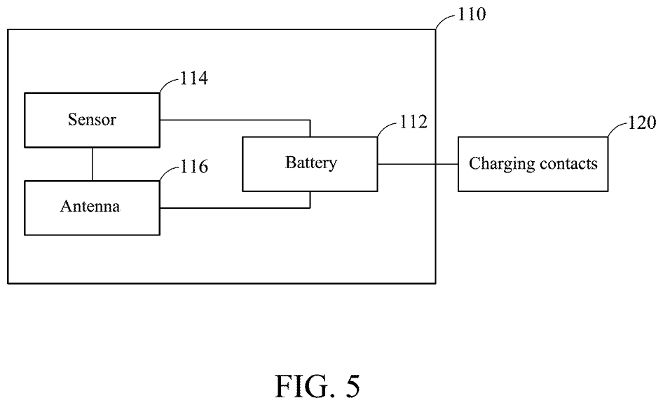

Referring to FIG. 5, a schematic block view of both the wireless signal module 110 and the charging contacts 120 in accordance with this disclosure is demonstrated. As shown in FIG. 2 and FIG. 5, the wireless signal module 110 of the tool holder 50 includes a battery 112, a sensor 114 and an antenna 116. The antenna 116 can be a wireless transmission component. The battery 112 for providing power is connected with the antenna 116 and the sensor 114. The sensor 114, receiving power from the battery 112, is used for detecting acceleration, inertia and temperature of the tool holder 50, especially while the tool holder 20 is in a machining process. In addition, in this embodiment, the charging contacts 120 of the tool holder 50 are to connect the battery 112. Thus, as long as the charging pins 132 contact the corresponding charging contacts 120, the battery 112 can charge the tool holder 50 directly. It shall be explained that, in this embodiment, structuring of the charging contacts 120 and the wireless signal module 110 are not specifically limited. In one embodiment, the charging contacts 120 can be spring structures such as spring plates or terminals for providing elastic contacts with the respective charging pins 132. In another embodiment, the charging contacts 120 can be magnetic structures such as magnets or magnetic materials for providing magnetic forces to hold the corresponding charging pins 132.

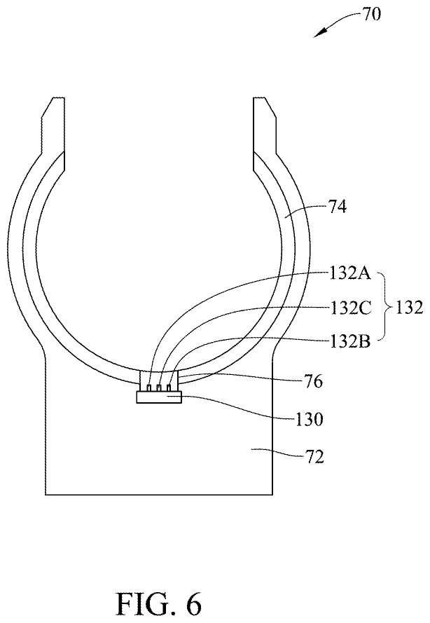

Referring to FIG. 6 and FIG. 7, an embodiment of the holder grabber for holding the tool holder 50 of this disclosure is shown. As shown in FIG. 1, FIG. 6 and FIG. 7, the holder grabber 70, formed as a tool claw, includes a base portion 72, a holder portion 74 and a key way 76. The holder portion 74 is used for clamping the tool holder 50 at the fixation portion 54. The key way 76, disposed across the holder portion 74 and the base portion 72, can be a groove for embedding detachably the charging module 130. In accordance with this disclosure, the charging module 130 can be provided into the key way 76 by embedding, buckling, screwing or any other means the like. The charging pins 132 and the charging cable 136 are located to opposing sides (upper and lower sides) of the holder portion 74. Thereupon, when the tool holder 50 is clamped by the tool claw 70 as shown in FIG. 7, the positive-pole terminal 132A of the charging pins 132 would meet the positive-pole contact 122, and the negative-pole terminal 132B thereof would meet the negative-pole contact 124. in the opposing side of the holder portion 74, the charging cable 136 extends outward to connect an external power supply.

Referring to FIG. 8, another embodiment of the charging device for a tool holder in accordance with this disclosure is schematically demonstrated. As shown in FIG. 1 and FIG. 8, the holder grabber 80, formed as a tubular holder in this embodiment, includes a sleeving tube 82 and a key way 84. The sleeving tube 82 is used for receiving the fixation portion 54 of the tool holder 50 with the connection portion 52 thereof to expose out of the sleeving tube 82. The key way 84 for mounting the charging module 130 is formed as a tooth protruding from an upper rim of the sleeving tube 82. Thereupon, when the tool holder 50 is held in position by the tubular holder 80, the positive-pole terminal 132A of the charging pins 132 would contact the positive-pole contact 122, and the negative-pole terminal 132B thereof would contact the negative-pole contact 124. In addition, the signal terminal 132C would be connected with the wireless signal module 110 to perform data transmission. Further, upon such an arrangement, the tubular holder 80 can detect directly a charging state and a tool-loading state of the tool holder 50, and thereby no sensor is necessary along a tool-loading path.

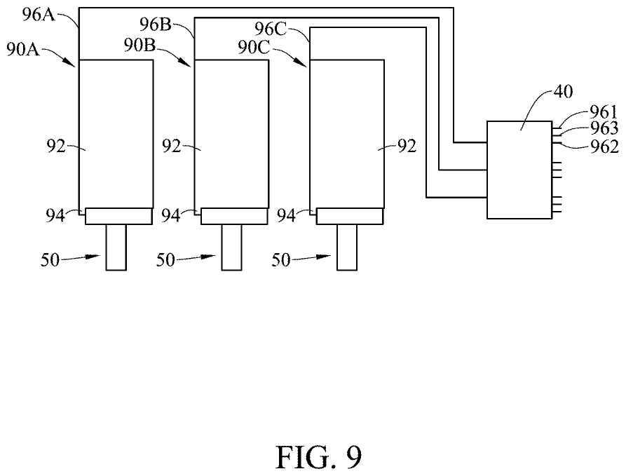

Referring to FIG. 9, a particular application of this disclosure is provided. As shown, a plurality of the aforesaid tubular holders 90A, 90B, 90C (three for example) is provided for receiving individual tool holders 50 for charging. Each of the tubular holders 90A, 90B, 90C includes a sleeving tube 92 and a key way 94, in which structuring of the sleeving tube 92 and the key way 94 can be referred to that thereof in FIG. 8. The tubular holders 90A, 90B, 90C can be arranged in a rotational tool magazine. The charging cables 96A, 96B, 96C are introduced individually to connect the corresponding charging modules into the respective tubular holders 90A, 90B, 90C. In order to avoid a cable-winding problem caused by rotation of the tool magazine with excessive cables, a power-transmitting device 40 can be introduced to connect the charging cable 96A, 96B, 96C. By having the power-transmitting device 40 to be located at a rotation center of the tool magazine, the charging cables 96A, 96B, 96C connected to the power-transmitting device 40 would be avoided from the unexpected winding trouble. Further, an external power supply (not shown in the figure) can be connected to the power-transmitting device 40. Similarly, each of the charging cables 96A, 96B, 96C can have a positive-pole terminal 961, a negative-pole terminal 962 and a signal terminal 963. In another embodiment not shown herein, the charging pins for each charging cable can have only a positive-pole terminal and a negative-pole terminal However, it shall be understood that the embodying of the charging pins can be various per different needs.

In summary, in the charging device for a tool holder provided by this disclosure, while the tool holder is positioned in the holder grabber, the tool holder can be then charged. In addition, since the tool holder would be sent back to the holder grabber such as the tool magazine, a tool frame or a tool storage after each usage, the practice of moving out all the tool folders for charging is no more necessary, and also the practice of replacing batteries for all the tool holders is not necessary as well. Thereupon, the charging device for the tool holders in this disclosure can significantly reduce the labor and time cost in the management of charging the tool holders.

In addition, according to this disclosure, even in a situation that no sensor is required along the loading path of the tool, the charging and tool-loading states can be directly detected at the tubular holder.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A charging device for a tool holder, the tool holder being disposed to a holder grabber, comprising:
a wireless signal module, disposed at the tool holder;
a plurality of charging contacts, disposed at the tool holder, each of the plurality of charging contacts being connected with the wireless signal module; and
a charging module, disposed at the holder grabber, including a plurality of charging pins; wherein, when the tool holder is positioned at the holder grabber, each of the plurality of charging pins contacts at the corresponding charging contact for charging the tool holder.

2. The charging device for a tool holder of claim 1, wherein each of the plurality of charging pins includes a positive-pole terminal and a negative-pole terminal, each of the plurality of charging contacts includes a positive-pole contact and a negative-pole contact, the positive-pole terminal contacts at the corresponding positive-pole contact, and the negative-pole terminal contacts at the corresponding negative-pole contact.

3. The charging device for a tool holder of claim 1, wherein the plurality of charging pins includes a positive-pole terminal, a negative-pole terminal and a signal terminal, each of the plurality of charging contacts includes a positive-pole contact and a negative-pole contact, the positive-pole terminal contacts at the corresponding positive-pole contact, the negative-pole terminal contacts at the corresponding negative-pole contact, and the signal terminal is connected with the wireless signal module.

4. The charging device for a tool holder of claim 1, wherein the wireless signal module is fixed to the tool holder by embedding, buckling or screwing.

5. The charging device for a tool holder of claim 1, wherein the charging module is fixed to a key way of the holder grabber by embedding, buckling or screwing.

6. The charging device for a tool holder of claim 1, wherein the charging module includes a charging cable.

7. The charging device for a tool holder of claim 6, further including a power-transmitting device connected with the charging cable, the charging cable being further connected with an external power supply.

8. The charging device for a tool holder of claim 1, wherein the wireless signal module further includes a battery, a sensor and an antenna, the charging contacts are connected with the battery, and the battery further connects both the antenna and the sensor.
